(19) United States
(12) Patent Application Publication
(10) Pub. No.: US 2017/0158848 A1
(43) Pub. Date: Jun. 8, 2017

(54) MATERIAL FOR PREVENTING ADHESION OF AQUATIC ORGANISMS

(71) Applicants: DAIKIN INDUSTRIES, LTD., Osaka-shi, Osaka (JP); OSAKA UNIVERSITY, Suita-shi, Osaka (JP)

(72) Inventors: Kazuya KAWAHARA, Settsu-shi, Osaka (JP); Kenji ADACHI, Settsu-shi, Osaka (JP); Kazuyuki SATOH, Settsu-shi, Osaka (JP); Akihiro OSHIMA, Ibaraki-shi, Osaka (JP)

(73) Assignees: DAIKIN INDUSTRIES, LTD., Osaka-shi, Osaka (JP); OSAKA UNIVERSITY, Suita-shi, Osaka (JP)

(21) Appl. No.: 15/316,550

(22) PCT Filed: Jun. 12, 2015
(86) PCT No.: PCT/JP2015/067032

§ 371 Date: Dec. 6, 2016

(30) Foreign Application Priority Data
Jun. 13, 2014 (JP) 2014-122670

(51) Int. Cl. C08L 27/18; C08J 5/04; E02D 31/00; C08J 5/18; A01N 25/34; A01N 29/00; C08J 5/24; C08J 5/10

(52) U.S. Cl. CPC C08L 27/18; C08J 5/24; C08J 5/042; C08J 5/10; C08J 5/18; A01N 25/34; A01N 29/00; E02D 31/00; C08J 2327/18; C08J 2495/00; E02D 2300/0051; E02D 2300/0053; E02D 2300/0068; E02D 2300/0064

(57) ABSTRACT

The present invention provides a material for preventing adhesion of an aquatic organism formed from a fluororesin and a fluorinated pitch.

### TECHNICAL FIELD

The present invention relates to a material for preventing adhesion of an aquatic organism to prevent any adhesion of an aquatic organism to an underwater structure by being attached to the underwater structure.

### BACKGROUND ART

As to various types of underwater structure such as, for example, a seawater intake facility in an electric power generating station, a large amount of the aquatic organisms (marine organisms), such as acorn barnacle, sea squirt, serpula, blue mussel, freshwater mussel, brown bryozoan, green laver, and sea lettuce, adhere to and grow on the surface thereof. It is worried that degradation of functions and failure of functions are caused by the aquatic organisms. Mechanical removal methods such as periodic scraping off of the adhering aquatic organisms also have traditionally been general while various antifouling paint have recently been developed and it is mainly conducted to apply the paints to the surface of the underwater structure, and thereby preventing any adhesion of the aquatic organism.

Examples of the antifouling paints include a poisonous antifouling agent such as an organic tin compound, copper suboxide, zinc pyrithione, copper pyrithione, and the like. For example, Patent Document 1 proposes an antifouling paint composition that comprises a binder including a starch fatty acid ester obtained by substituting hydroxyl groups of a starch or a starch-decomposed substance with one type or two or more types of fatty acid acyl group, and a repellent, wherein a formed paint film slowly releases the repellent by the water-solubilizing of the elements constituting the paint film, and an antifouling panel on which the paint film of the antifouling paint composition is formed.

On the other hand, a molded article for preventing adhesion of an aquatic organism is proposed that can achieve an effect of preventing adhesion of an aquatic organism without using any repellent. For example, Patent Document 2 discloses a molded article for preventing adhesion of an aquatic organism formed from a fluororesin that achieves an effect of preventing adhesion of an aquatic organism by setting the surface roughness Ra thereof to be 0.005 to 0.20 μm.

### PRIOR ART DOCUMENT

### Patent Document

Patent Document 1: Japanese Laid-Open Patent Publication No. 2006-233160
Patent Document 2: WO 2014/054685

### SUMMARY OF THE INVENTION

### Problem to be Solved by the Invention

The method using an antifouling paint composition such as that of Patent Document 1 can prevent the adhesion and the growth of the aquatic organisms while the method is disadvantageous concerning environment, safety, and hygiene during the production and the application of the paint because a repellent is used. In the water, the repellent is gradually dissolved from the paint film into the water and may pollute the waters in the long term. A problem has been found that when the method is used, the paint film of the antifouling paint composition formed on the surface of the panel is peeled off due to the degradation or the like, and it is difficult that a long-term effect is achieved.

Since the molded article for preventing adhesion of an aquatic organism such as that of Patent Document 2 uses no repellent, it can achieve the effect of preventing the adhesion of an aquatic organism without polluting the waters. However, the molded article for preventing adhesion of an aquatic organism such as that described in Patent Document 2 has an insufficient adhesion property for a base material to adhere directly to the base material, and the molded article needs another means such as an adhesive layer to be strongly attached to the base material.

An object of the present invention is therefore to provide a material for preventing adhesion of an aquatic organism that can achieve an effect of preventing adhesion of an aquatic organism without polluting the waters and that has a high adhesion property for a base material.

### Means to Solve the Problem

The inventors actively studied and, as a result, has found that a material for preventing adhesion of an aquatic organism that is able to achieve an effect of preventing adhesion of an aquatic organism without polluting waters and that has excellent adhesion property for a base material is able to be provided by using a material for preventing adhesion of an aquatic organism formed from a fluororesin and a fluorinated pitch, and the inventors thereby has completed the present invention.

According to a first aspect of the present invention, a material for preventing adhesion of an aquatic organism formed from a fluororesin and a fluorinated pitch is provided.

According to a second aspect of the present invention, an article is provided that includes a base material and the material for preventing adhesion of an aquatic organism adhering to the base material.

According to a third aspect of the present invention, an underwater structure is provided including the material for preventing adhesion of an aquatic organism or the article.

### Effect of the Invention

According to the present invention, a material for preventing adhesion of an aquatic organism can be acquired that can achieve an effect of preventing any adhesion of an aquatic organism for a long term without causing any environmental problem and that has a high adhesion property for a base material.

### BRIEF DESCRIPTION OF THE DRAWINGS

FIG. 1 shows a carbon six-membered ring portion of a fluorinated pitch.

FIG. 2 shows a structure that the six-membered ring portions in the fluorinated pitch is cross-linked with perfluorocarbon groups.

### EMBODIMENTS TO CARRY OUT THE INVENTION

Hereinafter, a material for preventing adhesion of an aquatic organism of the present invention will be described.

The material for preventing adhesion of an aquatic organism of the present invention is formed from a fluororesin and a fluorinated pitch.

The form of the material for preventing adhesion of an aquatic organism is, but not specifically limited, preferably, a molded article. In a preferred embodiment, the molded article is a molded article having the fluororesin and the fluorinated pitch which are cross-linked between each other.

The fluororesin is, but not specifically limited as long as it can be composited with the fluorinated pitch, preferably, polytetrafluoroethylene (PTFE), polyvinylidene fluoride (PVdF), polyvinyl fluoride (PVF), polychlorotrifluoroethylene (PCTFE), an ethylene-chlorotrifluoroethylene copolymer (ECTFE), a vinylidene fluoride-hexafluoropropylene copolymer (VdF-HFP), a vinylidene fluoride-tetrafluoroethylene copolymer (VdF-TFE), a vinylidene fluoride-tetrafluoroethylene-hexafluoropropylene copolymer (VdF-TFE-HFP), or a tetrafluoroethylene-based copolymer. Examples of the tetrafluoroethylene-based copolymer include, for example, an ethylene (Et)-tetrafluoroethylene (TFE) copolymer, a chlorotrifluoroethylene (CTFE)-TFE copolymer, a TFE-hexafluoropropylene (HFP) copolymer (FEP), a TFE-perfluoro(alkyl vinyl ether) (PAVE) copolymer (PFA), and the like.

As the fluororesin, preferably, polytetrafluoroethylene or tetrafluoroethylene-based copolymer is used and, especially preferably, polytetrafluoroethylene is used because it is chemically and thermally more stable.

The thermoplastic fluororesin preferably has a melting point equal to or higher than 100° C., for example, a melting point equal to or higher than 150° C., equal to or higher than 170° C., equal to or higher than 200° C., equal to or higher than 220° C., equal to or higher than 250° C., equal to or higher than 270° C., equal to or higher than 300° C., or equal to or higher than 320° C.

In an embodiment, the content of fluorine in the thermoplastic fluororesin may be equal to or higher than 20% by mass and may be, preferably, equal to or higher than 30% by mass, for example, equal to or higher than 40% by mass, equal to or higher than 50% by mass, equal to or higher than 60% by mass, equal to or higher than 70% by mass, or equal to or higher than 80% by mass.

In a preferred embodiment, the thermoplastic fluororesin has a melting point equal to or higher than 100° C. and contains fluorine of 20% by mass or higher. Preferably, the melting point and the fluorine content in the fluororesin may be equal to or higher than 100° C. and equal to or higher than 30% by mass, equal to or higher than 150° C. and equal to or higher than 20% by mass, or equal to or higher than 150° C. and equal to or higher than 30% by mass, respectively.

In the present invention, the “fluorinated pitch” is a compound obtained by fluorinating a coal-based or a petroleum-based pitch or coal tar. The fluorinated pitch can be obtained by substituting hydrogens in the pitch or the coal tar with fluorine in a fluorine gas, and is commercially available as, for example, Ogsol FP-S, Renoves (a registered trademark) P manufactured by Osaka Gas Chemical Co., Ltd., or the like.

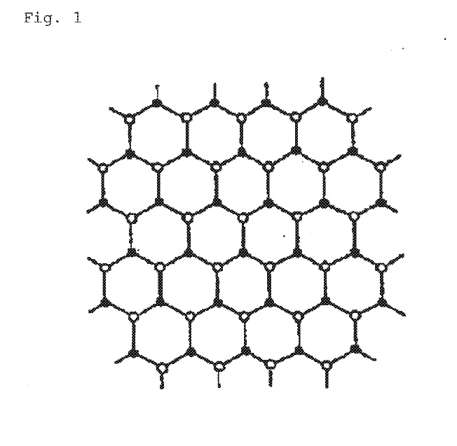

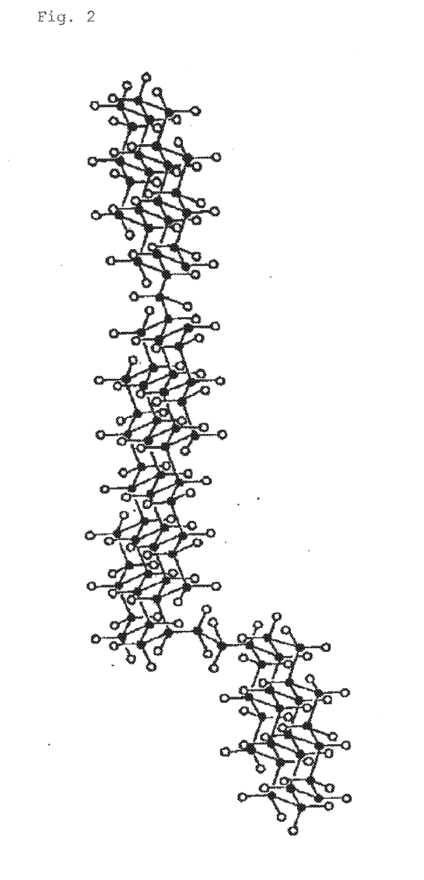

Preferably, the fluorinated pitch used in the present invention has a carbon six-membered ring portion as illustrated in FIG. 1. In FIG. 1, a black circle and a white circle represent a fluorine atom bonded on an upper side to a plane and a fluorine atom bonded on a lower side thereto, respectively. The carbon six-membered ring portion is same as (CF)ₙ. However, the overall (CF)ₙ has the layer structure and, in contrast, in the fluorinated pitch, the six-membered ring portions shown in FIG. 1 are cross-linked by perfluorocarbon groups (a group obtained by substituting hydrogen atoms of an aliphatic hydrocarbon group cross-linking the aromatic six-membered ring portions in the pitch with fluorine atoms). Such structure of the fluorinated pitch is shown in FIG. 2. In FIG. 2, a black circle represents a carbon atom and a white circle represents a fluorine atom. As to such structure, the layer state of the carbon six-membered ring portion is presumed using an electron microscope and the presence of the cross-links by the perfluorocarbon group is presumed using an X-ray photon spectroscopy [C₁ₛ electron spectroscopy for chemical analysis (ESCA) spectrum] and C¹³-NMR, according to a method similarly to a structural analysis for a pitch described in “Carbon”, Vol. 15, 17 (1977). In the fluorinated pitch, the layer structures of the cross-linked carbon six-membered rings are stacked to form a layered structure.

The fluorinated pitch substantially consists of carbon atoms and fluorine atoms. With respect to the fluorinated pitch, the F/C atomic ratio is 0.5 to 1.8, and the carbon six-membered rings are stacked. Furthermore, the fluorinated pitch is characterized by having the characteristics of (A) and (B) below.

(A) The fluorinated pitch can be formed into a film by vacuum deposition.

(B) The water contact angle of the fluorinated pitch at 30° C. is 141°±8°.

In an embodiment, the fluorine content in the fluorinated pitch may be equal to or higher than 40% by mass, preferably equal to or higher than 50% by mass, for example, equal to or higher than 60% by mass, and may be equal to or lower than 90% by mass, preferably equal to or lower than 80% by mass, for example, equal to or lower than 70% by mass.

The content of the fluorinated pitch is, preferably, 0.05 to 50 parts by weight, more preferably 0.1 to 30 parts by weight, further preferably 1 to 20 parts by weight with respect to 100 parts by weight of the fluororesin. The cross-link density becomes higher after the compositing with the fluororesin and the strength of the material for preventing adhesion of an aquatic organism can be enhanced by setting the amount of the fluorinated pitch to be equal to or larger than 0.05 parts by weight with respect to 100 parts by weight of the fluororesin. On the other hand, proper flexibility can be provided to the material for preventing adhesion of an aquatic organism by setting the amount of the fluorinated pitch to be equal to or smaller than 50 parts by weight. Since the content of the fluororesin is increased, the function of preventing adhesion of an aquatic organism of the material for preventing adhesion of an aquatic organism can be enhanced.

An average molecular weight of the fluorinated pitch is, but not particularly limited, preferably, 1,000 to 10,000, preferably 1,500 to 5,000, more preferably 2,000 to 3,000. An average particle diameter is, but not particularly limited, preferably 0.5 to 10 μm, for example, 1.0 to 5 μm, especially about 1.2 μm.

A softening temperature of the fluorinated pitch is, but not particularly limited, preferably 150 to 380° C., more preferably 180 to 300° C.

The material for preventing adhesion of an aquatic organism of the present invention can achieve the effect of preventing adhesion of an aquatic organism without polluting the surrounding environment since the material does not need to use any substance, such as a repellent, dissolved into the surrounding environment. In addition, the material for preventing adhesion of an aquatic organism of the present invention has a high adhesion property for a base material and can therefore be directly attached to the base material or an underwater structure. That is, the material for preventing adhesion of an aquatic organism of the present invention is easy to be attached to a base material or an underwater structure.

In a preferred embodiment, the material for preventing adhesion of an aquatic organism of the present invention further comprises a fiber material. The strength of the material for preventing adhesion of an aquatic organism can be enhanced by comprising the fiber material, and the material for preventing adhesion of an aquatic organism can therefore be obtained that can withstand a physical impact caused by a large and heavy suspended solid, for example, driftwood.

Examples of the fiber material include, but are not particularly limited to, for example, a fiber-reinforced plastic material (FRP), and may be either a continuous fiber material or a short fiber material. The fiber material is not particularly limited and, preferably, one type or two or more types of material selected from the group consisting of a polytetrafluoroethylene (PTFE) fiber, a glass fiber, a carbon fiber, a silicon carbide fiber, a silicon nitride fiber, an aramid fiber, a poly-paraphenylenebenzobisoxazole (PBO) fiber, and a metal fiber. A fiber is preferably used, having thermal resistance against a temperature, preferably equal to or higher than 150° C., more preferably equal to or higher than 250° C., further preferably equal to or higher than 300° C. As the fiber, carbon fiber woven cloth or glass fiber woven cloth is preferable. By using the fiber having the high thermal resistance, property change and degradation of the fiber during a heating step conducted later can be prevented.

The content of the fiber material is not particularly limited and may appropriately be varied depending on the type, the form, and the like of the used fiber material. The content of the fiber material is, preferably, 5 to 100 parts by weight, more preferably 10 to 40 parts by weight, further preferably 15 to 30 parts by weight with respect to 100 parts by weight of the total amount of the fluororesin and the fluorinated pitch.

The surface of the material for preventing adhesion of an aquatic organism of the present invention has the initial water contact angle, preferably, equal to or higher than 80°, more preferably equal to or higher than 90°. The upper limit of the contact angle is, but not particularly limited, preferably equal to or lower than 115°, more preferably equal to or lower than 110°. The material for preventing adhesion of an aquatic organism can acquire an enhanced function of preventing adhesion of an aquatic organism by having such initial water contact angle. The water contact angle can be measured using a contact angle meter.

The measurement of the contact angle in the present invention can be conducted based on the description in, for example, JIS R3257: 1999 “Testing Method for Wettability of Substrate Glass Surface”. Specifically, when a tangent line is drawn from a point at which a solid, a liquid and a gas (generally air) are in contact with each other to a curved face of the liquid, the angle formed by the tangent line and the surface of the solid is determined to be defined as the value of the contact angle. As the method for the measurement of the contact angle, a method is employed, that is called “sessile drop method” and a liquid droplet is left on the surface of the solid to determine the contact angle.

Examples of the aquatic organisms include, but are not particularly limited to, acorn barnacles, blue mussel, sea anemones, oyster, sea squirt, hydrozoan, bryozoan, various aquatic microorganisms, various seaweeds (such as Siphonocladales, Sargassum fulvellum, sea lettuce, green laver, etc.), diatoms, annelida (such as snail worm, calcareous tube worm, etc.), porifers (such as Tethya Lamarck, etc.), and the like.

The material for preventing adhesion of an aquatic organism of the present invention can be obtained by mixing the fluororesin and the fluorinated pitch, and optionally, conducting a post-process. Examples of the post-process include, for example, heat treatment, irradiation treatment, and a combination thereof. Preferably, the post-process is the irradiation treatment since finer cross-linking can be formed.

Hereinafter, the production method of the material for preventing adhesion of an aquatic organism of the present invention will be described in more detail with reference to an embodiment which contains the fluororesin, the fluorinated pitch, and the fiber material, although the production method of the material for preventing adhesion of an aquatic organism of the present invention is not limited thereto.

Firstly, powders of the fluorinated pitch is added to and mixed with a dispersion in which powder of the fluororesin is uniformly dispersed, to prepare a mixture of the fluororesin and the fluorinated pitch. The liquid for dispersing the powder, that is, a dispersion medium is not particularly limited, and may be a mixed solvent of water and an emulsifier, water and an alcohol, water and acetone, water, an alcohol, and acetone, or the like, and those skilled in the art can easily select and prepare them. As an alternative method, powder of the fluorinated pitch may be added to and mixed with fine powder of the fluororesin without using any dispersion.

Next, a fiber material is impregnated with the mixture obtained as described above. The impregnation method is not particularly limited and can be, for example, immersing of the fiber in the dispersion obtained as described above or applying of the dispersion to the fiber. After the impregnation, the dispersion medium is removed by drying and the fiber material which contains the fluororesin and the fluorinated pitch is obtained. Examples of the method of removing the dispersion medium include, for example, a method using evaporation by heat-drying, a method in which the sample after the impregnation and the drying is immersed in purified water and the dispersion medium is removed by diffusion from the inside, and the like.

Next, the fluororesin and the fluorinated pitch are reacted with each other by applying an irradiation process and/or heat treatment to the fiber material obtained as described above. By this reaction, the fluororesin is cross-linked and the fluorinated pitch and the fluororesin are chemically reacted with each other to be cross-linked therebetween. A composite material is therefore obtained, wherein the resin having a network structure molecular-compositively cross-linked strongly adheres to the fiber material.

When the heat treatment is conducted, the heating temperature is in a temperature range, for example, from 120 to 400° C., preferably a temperature equal to or higher than the softening point of the fluorinated pitch, for example, 180 to 300° C., preferably 270 to 300° C. By setting the heating temperature to be equal to or lower than 400° C., thermal decomposition of the fluororesin can be prevented. By setting the heating temperature to be equal to or higher than 120° C., the decomposition of the fluorinated pitch can be facilitated and radicals sufficient to start the reaction with the fluororesin can be produced.

As the heating means, an indirect or a direct heat source such as an ordinary gas circulation constant temperature oven, an infrared heater, or a panel heater can be used. Otherwise, the molding and the heat treatment may simultaneously be conducted using a hot-pressing molding machine or the like.

When the irradiation is conducted, the dosage of the radioactive ray is, preferably 0.1 kGy to 10 MGy, preferably 50 kGy to 1 MGy, further preferably 100 kGy to 500 kGy. By setting the dosage to be equal to or larger than 0.1 kGy, the concentration of the radicals contributing to the reaction can be increased and the property of the obtained composite material can be improved. On the other hand, by setting the dosage to be equal to or smaller than 10 MGy, degradation of the fiber material and degradation of the adhesion property for the fiber caused by the decomposition gases from the fluororesin can be suppressed and the cross-link density providing suitable flexibility can be obtained.

As the radioactive ray, an ionizing radioactive ray such as an electron beam, an X-ray, a neutron ray, or a high energy ion can be used, and these may be used alone or as a mixture. Preferably, the electron beam is used as the radioactive ray.

Preferably, the irradiation is conducted in an atmosphere having an oxygen concentration equal to or lower than 2,000 ppm, preferably equal to or lower than 100 ppm. The atmosphere having the oxygen concentration equal to or lower than 2,000 ppm can be established by controlling the oxygen concentration to be equal to or lower than 2,000 ppm, by reducing the pressure to produce a vacuum or by replacing oxygen in the atmospheric air with an inert gas such as helium, argon, or nitrogen. By using such atmosphere, radiation oxidation decomposition of the fluororesin can be prevented without suppressing cross-linking reaction of the fluororesin, during the irradiation. By setting the oxygen concentration to be equal to or lower than 2,000 ppm, slowing down of the progress of the cross linking reaction due to bonding of radicals induced by the radiation ray to oxygen can be suppressed.

Preferably, the irradiation is conducted in a temperature range from the room temperature (for example, 20° C.) to 400° C., and, preferably at a temperature equal to or higher than the softening temperature of the fluorinated pitch, for example, in a temperature range from 180 to 360° C. By setting the heating temperature to be equal to or lower than 400° C., thermal decomposition of the fluororesin can be prevented. By setting the heating temperature to be equal to or higher than 120° C., the production of the radicals can be facilitated. As the heating means for the temperature control, an indirect or a direct heat source such as an ordinary gas circulation constant temperature oven, an infrared heater, or a panel heater can be used. Otherwise, the heat generated by controlling the energy of the radioactive ray generated from an electron accelerator or an ion accelerator may be used as it is as the heat source.

A composite material having a higher network density can be obtained by applying the irradiation treatment as described above.

The network density of the cross-linked fluororesin in the composite material obtained as described above can arbitrarily be adjusted by controlling the amount of the fluorinated pitch to be added, the heating temperature, and/or the amount of the radioactive rays to be applied, depending on the desired strength and the desired flexibility of the material for preventing adhesion of an aquatic organism.

The network density of the cross-linked fluororesin is increased as the crystallization temperature (Tc) of the resin is decreased. More specifically, in the case where the change of the crystal by X-ray is measured, when the cross-link is formed, the diffraction intensity at 2θ=18° is reduced and the scattering at 2θ=16° is increased as the amount of the applied radioactive rays is increased. Similarly to the thermal analysis using the DSC, the variation of the diffraction intensity at each of 2θ=18° and 2θ=16° in the X-ray diffraction shows that the crystallinity degree is reduced together with the amount of the cross-linking radioactive rays, and the crystallization of the cross-linked fluororesin is suppressed by the cross-links. Based on this, the network density of the cross-linked fluororesin can quantitatively be estimated from the value of the difference in or the value of the ratio of the diffraction intensity between 2θ=18° and 2θ=16° in the X-ray diffraction.

In a preferred embodiment, the material for preventing adhesion of an aquatic organism of the present invention has suitable flexibility. For example, the tensile elastic modulus of the material may be 50 to 5,000 MPa, preferably 100 to 2,000 MPa. In a more preferred embodiment, the material for preventing adhesion of an aquatic organism of the present invention has bending strength of, for example, 10 to 200 MPa. Since the material for preventing adhesion of an aquatic organism has such flexibility, it is easy to apply the material to a base material or an underwater structure to which the material is to be attached and which has various shapes such as, for example, a part having a large curvature. The tensile elastic modulus and the bending strength of the material for preventing adhesion of an aquatic organism can be adjusted by controlling the content of the fiber material per unit volume of the material for preventing adhesion of an aquatic organism. For example, when the content of the fiber material per unit volume is high, the tensile elastic modulus and the bending strength are enhanced. The composite material is novel, which has the elastic modulus of 50 to 5,000 MPa or the bending strength of 10 to 200 MPa and is formed from the fluororesin, the fluorinated pitch, and the fiber material.

The tensile elastic modulus and the bending strength can be measured by conducting a three-point bending test for a molded plate in a shape of plate having a thickness of 1.4 mm, with the distance between the supporting points of 50 mm and at the cross-head speed of 1 mm/min.

Next, an article of the present invention will be described.

The article of the present invention includes a base material and the material for preventing adhesion of an aquatic organism of the present invention adhering to the base material.

Examples of the base material include base materials formed from various plastics such as polyimide, polyamide, polycarbonate, polyethylene terephthalate, vinyl chloride, or an acrylic resin, various metals such as iron, stainless steel, copper, aluminum, or nickel, or an alloy of these metals, or a construction material such as slate or concrete, and the like.

The method of attaching the material for preventing adhesion of an aquatic organism of the present invention to the surface of the base material is not particularly limited. Preferably, the material for preventing adhesion of an aquatic organism is contacted with the surface of the base material and the base material and the material for preventing adhesion of an aquatic organism are heated to adhere to each other. More preferably, a PTFE dispersion containing the fluorinated pitch is applied to the surface of the base material to contact the base material, and then they are heated to adhere to each other.

The present invention therefore provides also a production method of the article, comprising steps of contacting a material for preventing adhesion of an aquatic organism with a surface of a base material, and then heating them to adhere to each other, or applying a PTFE dispersion containing a fluorinated pitch to a surface of a base material, and thereby contacting the material for preventing adhesion of an aquatic organism with the surface of the base material, and then heating them to adhere to each other.

The heating temperature is, preferably, 100° C. to 400° C., more preferably equal to or higher than the softening temperature of the fluorinated pitch and equal to or lower than the decomposition temperature of the fluororesin, for example, 180° C. to 360° C.

As the heating means, an indirect or a direct heat source such as an ordinary gas circulation constant temperature oven, an infrared heater, a panel heater, or a heat gun can be used.

The material for preventing adhesion of an aquatic organism of the present invention can strongly adhere to the base material only by being heated as described above without using any adhesive. The present invention is not bound by any theory, although it is considered that this is because the fluorinated pitch in the material for preventing adhesion of an aquatic organism of the present invention is softened and functions as an adhesive.

The article comprising the material for preventing adhesion of an aquatic organism of the present invention can suppress adhesion of an aquatic organism for a long term by being directly attached to a structure to be prevented from adhesion of aquatic organisms, and is easily attached and detached at the place on which the structure is present.

Next, an underwater structure of the present invention will be described.

The underwater structure of the present invention comprises the material for preventing adhesion of an aquatic organism of the present invention or the article of the present invention.

Examples of the underwater structure include various types of structure regardless of whether the structure is used in seawater or freshwater. The structure may be the one used on the water surface. For example, the following articles and structures can be exemplified, although the structure is not limited thereto. In addition, the structure includes not only fixed structures such as a pier, a bridge support, and a channel but also structures for the main purpose of moving such as a mega-float and a ship.

Fixed Type:

underwater structures such as a bridge, a concrete block, a wave absorbing block, a breakwater, and a pipeline;

harbor facilities such as a water gate door, an offshore tank, and a floating pier;

sea bottom work facilities such as a submarine drilling facility and a submarine communication cable facility;

thermal, atomic, tidal, and ocean thermal energy conversion electric power generating facilities such as a headrace channel, a condensing pipe, a water chamber, a water intake, and a water discharge port;

water supply, discharge, and storage facilities such as a pool, a water tank, a water tower, a sewage line, and a rain gutter; and

domestic facilities such as a fitted kitchen, a flush toilet, a bathroom, and a bathtub.

Moving Type:

ship structures or accessories of ships such as a draft part or a ship bottom of a ship, an exterior of a submarine, a screw, a propeller, and an anchor;

articles used on the water surface or underwater; and

materials for floats of a pontoon plane, and the like.

Fixed Type:

articles for fishery such as fishing nets such as a fixed fishing net, a buoy, a corf, and a rope;

articles for thermal, atomic, tidal, offshore wind, and ocean thermal energy conversion electric power generation such as a condenser and a water chamber;

sea bottom (water bottom) laid articles such as a undersea (underwater) cable; and

Moving Type:

articles for fishery such as a drag net and a longline.

The present invention also provides a method to prevent adhesion of an aquatic organism to an underwater structure, comprising a step of attaching the material for preventing adhesion of an aquatic organism of the present invention or the article of the present invention to the underwater structure.

The method of attaching the material for preventing adhesion of an aquatic organism of the present invention or the article of the present invention to the underwater structure of the present invention is not particularly limited. The material for preventing adhesion of an aquatic organism may directly be attached to the underwater structure, or an article may be formed by attaching the material for preventing adhesion of an aquatic organism to the base material and the article may be attached to the underwater structure.

The method of directly attaching the material for preventing adhesion of an aquatic organism to an underwater structure is not particularly limited. An adhesive may be used or, similarly to the attachment to the article, the material for preventing adhesion of an aquatic organism can be attached to an underwater structure by being contacted with the underwater structure and heated.

Examples of the method of attaching the article of the present invention to an underwater structure include a method using an adhesive and a method using an attachment such as an anchor bolt.

### EXAMPLES

### Production Example 1

100.0 parts by weight of polytetrafluoroethylene (PTFE) dispersion (D-210C, a solid content of 62.3%, manufactured by Daikin Industries, Ltd., and a melting point of 327° C. and a fluorine content of 76%) and 1.25 parts by weight of fluorinated pitch (Ogsol FP-S, manufactured by Osaka Gas Chemical Co., Ltd.) were mixed to obtain a mixture liquid in which these components were uniformly dispersed.

### Example 1

50 parts by weight of carbon fiber woven cloth T300 (manufactured by Toray Industries, Inc.) comprising a high performance carbon fiber formed from polyacrylnitrile (PAN) as the raw material was impregnated with 50 parts by weight of the mixture liquid obtained in Production Example 1, wind-dried, and thereafter heated at 360° C. for 5 minutes. Then, the woven cloth impregnated with the mixture liquid was cooled to 320° C. to be in its supercooling state and cross-linked by applying an electron beam of 150 kGy, acceleration voltage of 250 kV and acceleration current of 1 mA, for 1 minute using an electron beam accelerator to obtain a sheet-like material for preventing adhesion of an aquatic organism.

### Example 2

A sheet-like material for preventing adhesion of an aquatic organism was obtained similarly to Example 1 except that the radiation dose was set to be 500 kGy (the acceleration voltage was 250 kV and the acceleration current was 1 mA) in Example 1.

### Experimental Example 1

The following tests were conducted for the materials for preventing adhesion of an aquatic organism obtained in Examples 1 and 2. The same tests were conducted for a commercially available polytetrafluoroethylene (PTFE) sheet (Comparative Example 1, manufactured by Nichias Corporation) and a vinyl chloride sheet (Comparative Example 2, manufactured by Sumitomo Bakelite Co., Ltd.) as a Comparative Example.

### (Contact Angle)

The initial contact angle to water was measured for each of the above sheets. Specifically, the initial static contact angle was measured for 2 μL of water using a contact angle measuring apparatus.

(Acorn Barnacle Adhesion Test)

The effects of preventing adhesion for various test items under running water were evaluated by hanging down the sheets together with a mesh testing container in a seawater circulating water tank, and observing adhesion state of acorn barnacle larvae in the adhesion stage which were moved into the testing container to the test items.

Specifically, the evaluation was conducted by calculating the rate of the number of acorn barnacle larvae in the adhesion stage (n) which adhered to the test item, to the number of moved acorn barnacle larvae in the adhesion stage (no). The adhesion rate was calculated according to the equation below.

n/n₀×100(%)

(Adhesion Durability)

Each of the sheets was put on a stainless steel metal panel base material and heated to 300° C. using a heat gun to be subjected to an adhesion process, and a sheet panel was obtained. Then, the sheet panel was attached to an underwater structure using anchor bolts and immersed in water to be left for several days. Then, the sheet panel was observed. The adhesion durability between the sheet and the base material panel after the processing was evaluated by visual observation according to the following criteria.

∘ . . . Not peeled

Δ . . . Partially peeled

x . . . Peeled

The results of the test are collectively shown in the table below.

TABLE 1

| | | | Acorn Barnacle Adhesion Test | | | |
|---|---|---|---|---|---|---|
| | | | | Adhesion | Adhesion | |
| | | | Initial | Rate One | Rate Two | |
| | Radi- | | Adhe- | Week | Weeks | Adhesion |
| | ation | Contact | sion | after | after | Durability |
| | Dose | Angle | Rate | Dropout | Dropout | to Base |
| | (kGy) | (°) | (%) | Test (%) | Test (%) | Material |
| Example 1 | 150 | 90.1 | 2.1 | 2.1 | 2.1 | ∘ |
| Example 2 | 500 | 90.1 | 2.1 | 2.1 | 2.1 | ∘ |
| Compar- | — | 87.0 | 3.1 | 3.1 | 3.1 | x |
| ative | | | | | | |
| Example 1 | | | | | | |
| Compar- | — | 60.2 | 70.2 | 70.2 | 70.2 | Δ |
| ative | | | | | | |
| Example 2 | | | | | | |

From the above results, it was confirmed that Example 1 and Example 2 using the material for preventing adhesion of an aquatic organism of the present invention provided an excellent effect of preventing adhesion of an aquatic organism for a long term and had also excellent adhesion property to the base material.

### INDUSTRIAL APPLICABILITY

The material for preventing adhesion of an aquatic organism of the present invention can be applied to a headrace channel, a condensing pipe, a water intake, and a water discharge port of an electric power generating station, underwater structures such as harbor facilities, buoys, pipelines, bridges, submarine bases, submarine oil field drilling equipment, and ships, ballast tanks, and decks.

1. A material for preventing adhesion of an aquatic organism formed from a fluororesin and a fluorinated pitch.

2. The material for preventing adhesion of an aquatic organism according to claim 1, wherein
the fluororesin is polytetrafluoroethylene or a tetrafluoroethylene-based copolymer.

3. The material for preventing adhesion of an aquatic organism according to claim 1, wherein
a content of the fluorinated pitch is 0.05 to 50 parts by weight with respect to 100 parts by weight of the fluororesin.

4. The material for preventing adhesion of an aquatic organism according to claim 1, further comprising a fiber material.

5. The material for preventing adhesion of an aquatic organism according to claim 4, wherein
the fiber material is one type or two or more types of fiber selected from the group consisting of a polytetrafluoroethylene fiber, a glass fiber, a carbon fiber, a silicon carbide fiber, a silicon nitride fiber, an aramid fiber, a poly-paraphenylenebenzobisoxazole fiber, and a metal fiber.

6. The material for preventing adhesion of an aquatic organism according to claim 1, wherein
the fluororesin and the fluorinated pitch are cross-linked by irradiation or heat treatment to form a network structure.

7. The material for preventing adhesion of an aquatic organism according to claim 6, wherein
the cross-links are formed by irradiation treatment.

8. An article comprising:
a base material; and
the material for preventing adhesion of an aquatic organism according to claim 1 adhering to the base material.

9. An underwater structure comprising:
the material for preventing adhesion of an aquatic organism according to claim 1.

10. An underwater structure comprising:
the article according to claim 8.
